(19) United States
(12) Patent Application Publication
(10) Pub. No.: US 2025/0193523 A1
(43) Pub. Date: Jun. 12, 2025

(54) IMAGE PICKUP APPARATUS

(71) Applicant: CANON KABUSHIKI KAISHA, Tokyo (JP)

(72) Inventor: YUJI UEDA, Tokyo (JP)

(21) Appl. No.: 18/943,333

(22) Filed: Nov. 11, 2024

(30) Foreign Application Priority Data
Dec. 12, 2023 (JP) 2023-209448

(51) Int. Cl. H04N 23/68

(52) U.S. Cl. CPC H04N 23/687; H04N 23/6812

(57) ABSTRACT

An image pickup apparatus includes a fixed member, a movable member holding an image sensor and movable in a direction orthogonal to an optical axis, a drive unit that drives the movable member, a rollable member disposed between the fixed and movable members, a first yoke member disposed on the fixed member, a second yoke member disposed on the movable member, and a magnet member disposed on the first or second yoke member. A surface of the first yoke member and a surface of the second yoke member overlap each other in a first direction orthogonal to an optical axis direction. A surface of the first yoke member and a surface of the second yoke member overlap each other in a second direction parallel to the optical axis. The magnet, first yoke, and second yoke members form a magnetic circuit passing through the first to fourth surfaces.

### BACKGROUND

### Technical Field

The disclosure relates to an image pickup apparatus.

### Description of Related Art

An image pickup apparatus having an image stabilizing mechanism driven by a voice coil motor (VCM) has conventionally been known. Such an image stabilizing mechanism can reduce image blur by moving a movable portion that holds an image sensor in a plane relative to a fixed portion. The image pickup apparatus having the image stabilizing mechanism that moves the image sensor using the VCM is to constantly generate a driving force by energizing a coil to hold the movable portion, in order to properly maintain the position of the image sensor. Thus, power consumption is likely to increase and the capturable number of shots is likely to reduce.

Japanese Patent Laid-Open No. 2018-180258 discloses an image pickup apparatus having a gravity support portion that supports a movable portion with a force equal to the gravity acting on the movable portion. Japanese Patent Laid-Open No. 2021-166334 discloses an image pickup apparatus that assists in holding the movable portion utilizing a reaction force caused by bending a flexible printed circuit (FPC) that electrically connects an image sensor and a control board.

The image pickup apparatus disclosed in Japanese Patent Laid-Open No. 2018-180258 requires the gravity support portion to support the movable portion, and thus the image pickup apparatus becomes complicated and large. The structure disclosed in Japanese Patent Laid-Open No. 2021-166334 cannot reduce power consumption depending on the attitude of the image pickup apparatus.

### SUMMARY

An image pickup apparatus according to one aspect of the disclosure includes a fixed member, a movable member holding an image sensor and movable relative to the fixed member in a direction orthogonal to an optical axis, a drive unit configured to drive the movable member, a rollable member disposed between the fixed member and the movable member, a first yoke member disposed on the fixed member, a second yoke member disposed on the movable member, and a magnet member disposed on one of the first yoke member and the second yoke member. A first surface of the first yoke member and a second surface of the second yoke member overlap each other in a first direction orthogonal to an optical axis direction. A third surface of the first yoke member and a fourth surface of the second yoke member overlap each other in a second direction parallel to the optical axis. The magnet member, the first yoke member, and the second yoke member form a magnetic circuit passing through the first surface, the second surface, the third surface, and the fourth surface.

Further features of various embodiments of the disclosure will become apparent from the following description of embodiments with reference to the attached drawings.

### BRIEF DESCRIPTION OF THE DRAWINGS

FIG. 1 is a schematic diagram of an imaging system according to this embodiment.

FIG. 2 is an exploded perspective view of an image stabilizing unit according to this embodiment.

FIG. 3 is an exploded perspective view of the image stabilizing unit according to this embodiment.

FIG. 4 is an exploded perspective view of a movable portion according to this embodiment.

FIG. 5 is an exploded perspective view of the movable portion according to this embodiment.

FIG. 6 is a perspective view of a drive flexible printed circuit (FPC) according to this embodiment.

FIGS. 7A to 7C explain a holding assist structure according to this embodiment.

FIG. 8 is a sectional view of a holding assist structure according to a variation.

FIG. 9 is a top view of the holding assist structure according to this embodiment.

FIGS. 10A to 10C are front views of the holding assist structure according to this embodiment.

### DETAILED DESCRIPTION

Referring now to the accompanying drawings, a detailed description will be given of embodiments according to the disclosure. A description will now be given of an example structure that applies a drive apparatus according to this embodiment to an image stabilizing apparatus in an image pickup apparatus, but the application example of the drive apparatus according to the present disclosure is not limited to the image pickup apparatus.

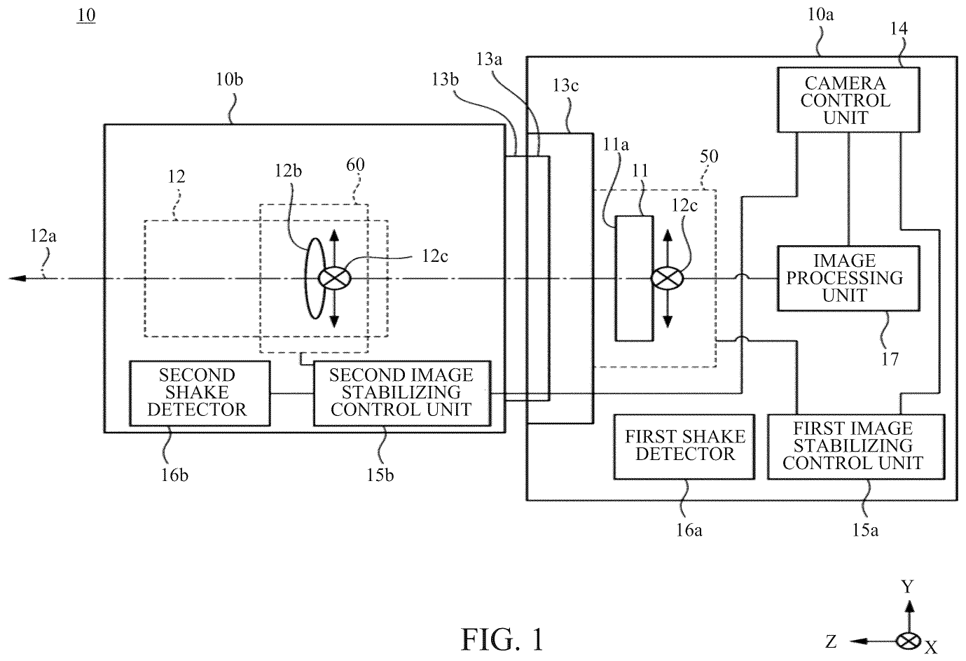

Referring now to FIG. 1, a description will be given of an imaging system 10 according to this embodiment. FIG. 1 is a schematic configuration diagram of the imaging system 10. The imaging system 10 is a so-called mirrorless digital camera, and includes a body unit 10a as an image pickup apparatus (camera body), and a lens apparatus (interchangeable lens) 10b attachable to and detachable from the body unit 10a. This embodiment is not limited to this example, and is applicable to an image pickup apparatus in which the body unit and the lens apparatus are integrated.

The body unit 10a includes an image sensor 11 having an imaging surface 11a, a base member 13c, a mount member (body-unit mount member) 13a, a camera control unit 14, a first image-stabilizing control unit 15a, a first shake detector 16a, an image processing unit 17, and a first image stabilizing unit 50. The first image-stabilizing control unit 15a is a control unit configured to control a drive unit that drives a holding member 31. The lens apparatus 10b includes an imaging optical system 12 including an image stabilizing lens 12b, a mount member (lens-side mount member) 13b, a second image-stabilizing control unit 15b, a second shake detector 16b, and a second image stabilizing unit 60.

A virtual light ray that is a representative light beam irradiated onto the imaging surface 11a of the image sensor 11 through the imaging optical system 12 will be called an optical axis (imaging optical axis) 12a, and a plane orthogonal to the optical axis 12a will be called an optical-axis orthogonal plane 12c. The optical axis 12a passes through the center of the imaging surface 11a and is orthogonal to the imaging surface 11a. In order to clarify the arrangement within the imaging system 10 of and positional relationship among components in the imaging system 10, an X direction, a Y direction, and a Z direction, which are orthogonal to one another, will be defined. The Z direction is parallel to the optical axis 12a, the X direction is a width direction (horizontal direction) of the imaging system 10, and the Y direction is a height direction (vertical direction) of the imaging system 10. In a case where the X direction and the Z direction are both in a horizontal plane, the Y direction is the vertical direction. Therefore, the optical-axis orthogonal plane 12c is the XY plane. The attitude (camera attitude or orientation) of the imaging system 10 in a case where the Z direction coincides with the direction of the optical axis 12a will be called a “normal position.”

The image sensor 11 is a photoelectric conversion element such as a Complementary Metal-Oxide-Semiconductor (CMOS) image sensor or a Charge Coupled Device (CCD) image sensor. The image sensor 11 is disposed so that the imaging surface 11a faces the object side (lens apparatus 10b side) and is orthogonal to the optical axis 12a. The image sensor 11 generates an image signal by photoelectrically converting an optical image of an object formed on the imaging surface 11a by the imaging optical system 12. The image signal generated by the image sensor 11 is converted into image data by performing various processing in the image processing unit 17, and is stored in an unillustrated memory (storage device). The camera control unit 14 is a calculator in an unillustrated main IC, and controls an overall operation of the imaging system 10 by accepting an input operation from a user via an unillustrated operation unit.

The imaging optical system 12 includes an unillustrated lens unit disposed inside the lens apparatus 10b, and images reflected light from an unillustrated object on the imaging surface 11a of the image sensor 11. In the imaging system 10, in order to dispose the image sensor 11 with high positional accuracy relative to the optical axis 12a, the image sensor 11 is attached to the base member 13c in the body unit 10a, and the lens apparatus 10b is also connected to the base member 13c. At that time, the image sensor 11 is attached to the base member 13c via the first image stabilizing unit 50. The lens apparatus 10b is connected to the base member 13c via the mount member 13b of the lens apparatus 10b and the mount member 13a of the body unit 10a.

The first image stabilizing unit 50 corrects image blur caused by shaking in the imaging system 10 by moving the image sensor 11 in a direction orthogonal to the optical axis 12a (which will sometimes be referred to as an optical-axis orthogonal direction hereinafter) or rotating it within the optical-axis orthogonal plane 12c, so as to acquire a clear object image. More specifically, as the attitude of the imaging system 10 changes relative to the object during imaging, the imaging position of an object light beam on the imaging surface 11a of the image sensor 11 changes, and an obtained through the image sensor 11 blurs. In this case, in a case where the attitude change of the imaging system 10 is sufficiently small, the change in the imaging position is uniform within the imaging surface 11a and can be regarded as a translational or rotational movement (image surface blur) within the optical-axis orthogonal plane 12c. Therefore, by translating or rotating the image sensor 11 in the optical-axis orthogonal plane 12c so as to cancel out the image blur, a clear object image with image blur corrected can be obtained. In moving the image sensor 11 in a direction parallel to the imaging surface 11a, the image sensor 11 may be moved in a direction orthogonal to the imaging surface 11a.

Similarly, the second image stabilizing unit 60 corrects image blur caused by a shake occurring in the imaging system 10 by moving the image stabilizing lens 12b in an optical-axis orthogonal direction or rotates it in the optical-axis orthogonal plane 12c, so as to obtain a clear object image. That is, by moving the image stabilizing lens 12b in an optical-axis orthogonal direction, the optical axis 12a is refracted. At this time, the image stabilizing lens 12b is moved in the optical-axis orthogonal direction so as to cancel out the image blur. Thereby, a clear object image with image blur corrected can be obtained. Since the image stabilization principle that moves the image sensor 11 or the image stabilizing lens 12b is well known, a detailed description will be omitted. While the image stabilizing lens 12b is moved in the optical-axis orthogonal direction, the image stabilizing lens 12b may also be moved in the optical axis direction.

The first image stabilizing unit 50 includes a fixed portion 20, a movable portion 30, and a plurality of drive force generators. The fixed portion 20 is fixed to the base member 13c, and the movable portion holds the image sensor 11. The movable portion 30 is supported by the fixed portion 20 with three degrees of freedom, and can move in the optical-axis orthogonal direction relative to the fixed portion 20 and rotate within the optical-axis orthogonal plane 12c. In other words, the first image stabilizing unit 50 is configured as a drive apparatus (so-called XYθ stage) capable of drive control on three axes, and can move the image sensor 11 in the optical-axis orthogonal direction and rotate it within the optical-axis orthogonal plane 12c.

The second image stabilizing unit 60 includes a fixed portion, a movable portion, and a plurality of drive force generators. The fixed portion is fixed to an unillustrated housing of the lens apparatus 10b, and the movable portion holds the image stabilizing lens 12b. The movable portion is supported by the fixed portion with two degrees of freedom, and can move in the optical-axis orthogonal direction relative to the fixed portion. In other words, the second image stabilizing unit 60 is configured as a drive apparatus (so-called XY stage) capable of drive control in two axes, and can move the image stabilizing lens 12b in an optical-axis orthogonal direction.

Each of the first shake detector 16a and the second shake detector 16b includes a gyro sensor or an acceleration sensor, etc., and detects an angular velocity or acceleration, etc. in each direction of the imaging system 10 as shake information on the imaging system 10. Each of the first image-stabilizing control unit 15a and the second image-stabilizing control unit 15b calculates an angular change amount or moving amount in each direction of the imaging system 10 as shake information by integrating the angular velocity or acceleration detected by the first shake detector 16a and the second shake detector 16b. The first image-stabilizing control unit 15a also calculates a moving target value of the image sensor 11 based on the shake information detected by the first shake detector (first detector) 16a, and controls the driving of the first image stabilizing unit 50. Thereby, the movement of the image sensor 11 can be controlled. Similarly, the second image-stabilizing control unit 15b calculates a moving target value of the image stabilizing lens 12b based on the shake information detected by the second shake detector 16b, and controls the driving of the second image stabilizing unit 60. Thereby, the movement of the image stabilizing lens 12b can be controlled.

The imaging system 10 may include only one of the first image stabilizing unit 50 and the second image stabilizing unit 60. In a case where the imaging system 10 does not include the first image stabilizing unit 50, the image sensor 11 is fixedly disposed relative to the optical axis 12a. On the other hand, in a case where the imaging system 10 does not include the second image stabilizing unit 60, the image stabilizing lens 12b is basically unnecessary. In other words, the imaging optical system 12 in the lens apparatus 10b is designed to obtain a desired optical characteristic with a lens configuration that does not include the image stabilizing lens 12b.

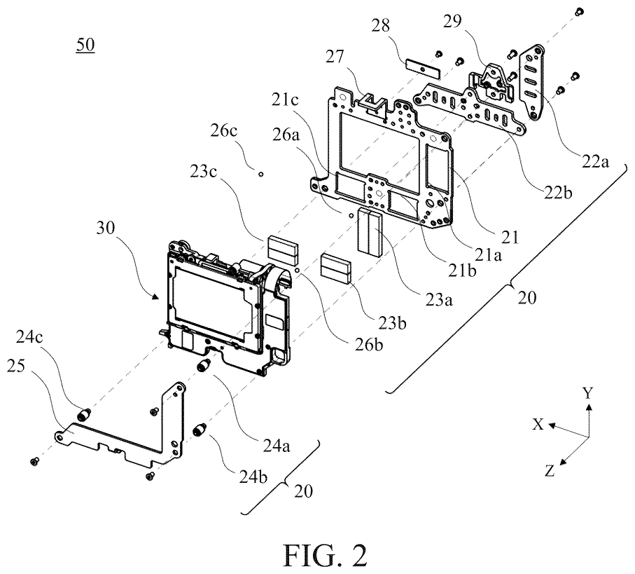

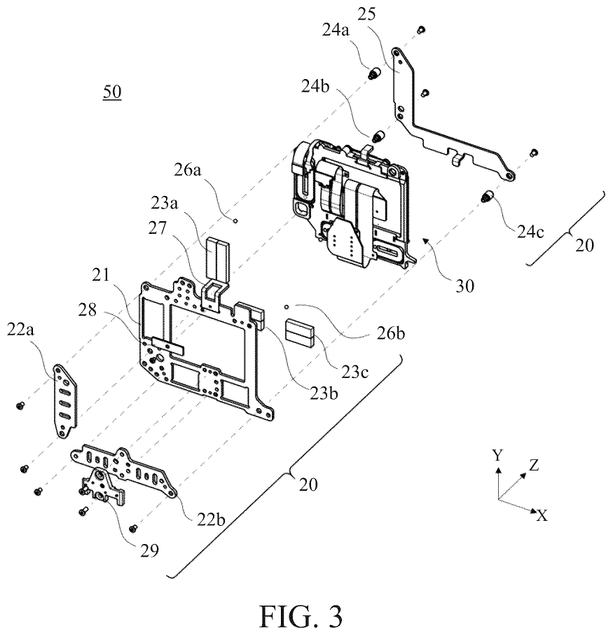

Referring now to FIGS. 2 and 3, a description will be given of a detailed structure of the image stabilizing unit (first image stabilizing unit 50). The structure of the second image stabilizing unit 60 is similar to that of the first image stabilizing unit 50, and thus a description thereof will be omitted. FIGS. 2 and 3 are exploded perspective views of the first image stabilizing unit 50. FIG. 2 illustrates the first image stabilizing unit 50 viewed from the object side, and FIG. 3 illustrates the first image stabilizing unit viewed from the image side. The first image stabilizing unit 50 includes the fixed portion 20 and the movable portion 30. In FIGS. 2 and 3, the movable portion 30 is illustrated not exploded, and the fixed portion 20 is illustrated exploded.

The fixed portion 20 includes a base plate (fixed member) 21, a first rear yoke 22a, a second rear yoke 22b, a first rear magnet unit 23a, a second rear magnet unit 23b, and a third rear magnet unit 23c. A first opening 21a, a second opening 21b, and a third opening 21c are formed in the base plate 21. The first rear magnet unit 23a, the second rear magnet unit 23b, and the third rear magnet unit 23c are fixed to the first rear yoke 22a and the second rear yoke 22b, respectively, with an adhesive or the like. The first rear magnet unit 23a, the second rear magnet unit 23b, and the third rear magnet unit 23c are arranged so as to be surrounded by the first opening 21a, the second opening 21b, and the third opening 21c, respectively. The first rear yoke 22a and the second rear yoke 22b are fixed to the base plate 21 with screws.

In this embodiment, the first rear magnet unit 23a, the second rear magnet unit 23b, and the third rear magnet unit 23c are formed by arranging two magnets magnetized in the optical axis direction (Z direction) so as to generate magnetic fields in opposite directions. This embodiment is not limited to this example, and a single magnet magnetized with two poles may be used.

The fixed portion 20 includes a first support member 24a, a second support member 24b, a third support member 24c, and a front yoke 25. The front yoke 25 is fixed to the base plate 21 with screws via the first support member 24a, the second support member 24b, and the third support member 24c. The first support member 24a, the second support member 24b, and the third support member 24c are restricting portions that are disposed at positions that restrict the movement of the movable portion 30, and restrict the movement of the movable portion 30 to a predetermined range in the optical-axis orthogonal plane 12c. A buffer material such as rubber is provided at contact locations of the first support member 24a, the second support member 24b, and the third support member 24c with the movable portion 30 and absorb impacts at the time of contact, thereby preventing damage and reducing impact noise.

The first rear yoke 22a and the front yoke 25 are arranged to sandwich the first rear magnet unit 23a in the optical axis direction, and the first rear magnet unit 23a forms a first magnetic circuit that passes through the first rear yoke 22a and the front yoke 25. Similarly, the second rear yoke 22b and the front yoke 25 are arranged to sandwich the second rear magnet unit 23b and the third rear magnet unit 23c in the optical axis direction. The second rear magnet unit 23b and the third rear magnet unit 23c form the second magnetic circuit and the third magnetic circuit, respectively.

The fixed portion 20 further includes a first thrust yoke (first yoke member) 27, a fixed metal plate 28, and a base member 29. The first thrust yoke 27 is disposed at a position facing a thrust magnet (magnet member) 38 described later, and is fastened to the fixed metal plate 28 with a screw. The fixed metal plate 28 is fixed to the base plate 21 with a screw or adhesive (not illustrated). In this embodiment, the first thrust yoke 27 is configured as a single part, but it may be integrated with the base plate 21. In that case, the base plate 21 is formed of a magnetic material, and the fixed metal plate 28 is unnecessary. The base member 29 is fixed to the base plate 21 with a screw together with the second rear yoke 22b, and a drive FPC 34a described later is attached.

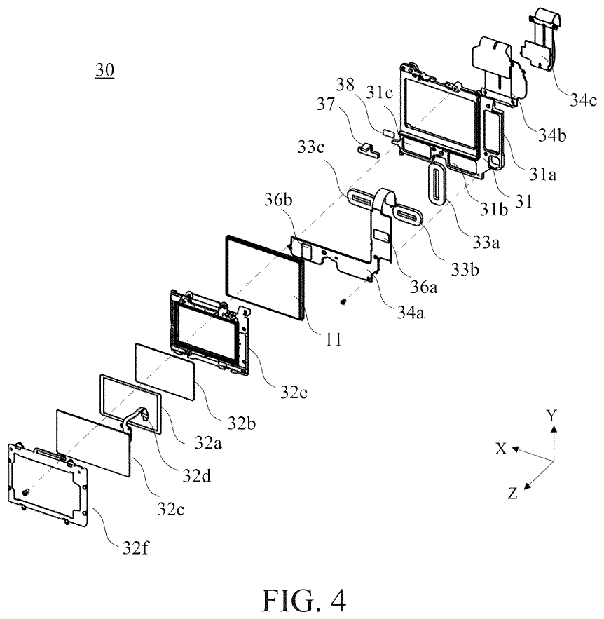

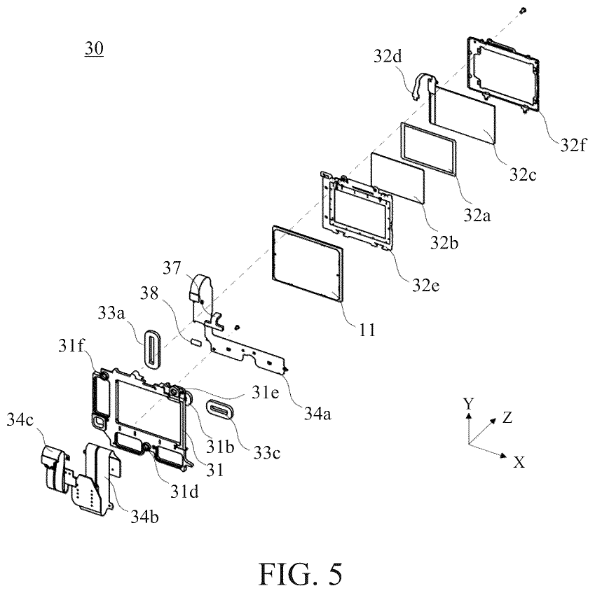

Referring now to FIGS. 4 and 5, a description will be given of a detailed structure of the movable portion 30 constituting the image stabilizing unit. FIGS. 4 and 5 are exploded perspective views of the movable portion 30. FIG. 4 illustrates the movable portion 30 viewed from the object side, and FIG. 5 illustrates the movable portion 30 viewed from the image side.

The movable portion 30 includes an image sensor 11 and a holding member (movable member) 31 that holds the image sensor 11. The image sensor 11 is fixed to the holding member 31 with an adhesive or the like. The holding member 31 is movable relative to the base plate 21 in an direction orthogonal to the optical axis 12a.

The movable portion 30 further includes a mask 32a, an infrared absorption filter 32b, an optical low-pass filter 32c, and a vibration unit 32d. The mask 32a, the infrared absorption filter 32b, and the optical low-pass filter 32c are held by a holder member 32e and a holder metal plate 32f, and are fixed to the image sensor 11 with an adhesive or the like. The mask 32a prevents unnecessary light outside the imaging optical path from entering the image sensor 11. The optical low-pass filter 32c reduces moiré caused by the repetitive pattern of the object. The vibration unit 32d is provided to the optical low-pass filter 32c, and removes foreign matters such as dust adhering to the surface of the optical low-pass filter 32c by vibrating the optical low-pass filter 32c. The foreign matter removing principle and control by the vibration unit 32d are well known, so a detailed description will be omitted.

The movable portion 30 further includes a first coil 33a, a second coil 33b, a third coil 33c, and a drive FPC 34a. The drive FPC 34a is disposed so as to overlap the first coil 33a, the second coil 33b, and the third coil 33c on the optical-axis projection surface (on the XY plane when viewed from the Z direction), and is fixed to the holding member 31 with screws, adhesive, or the like.

The holding member 31 further includes a first concave portion 31a, a second concave portion 31b, and a third concave portion 31c. The first coil 33a, the second coil 33b, and the third coil 33c are disposed in the first concave portion 31a, the second concave portion 31b, and the third concave portion 31c, respectively, and are fixed to the holding member 31 with an adhesive or the like.

The first magnetic circuit (first rear magnet unit 23a) and the first coil 33a form a VCM serving as a first actuator. The second magnetic circuit (second rear magnet unit 23b) and the second coil 33b form a VCM serving as a second actuator. The third magnetic circuit (third rear magnet unit 23c) and the third coil 33c form a VCM serving as a third actuator. The first actuator, the second actuator, and the third actuator constitute a drive unit configured to drive the holding member 31.

A Lorentz force is generated in a direction orthogonal to the magnetic field generated in the optical axis direction by the first magnetic circuit and the current flowing through the first coil 33a, and a resultant direction of the Lorentz force changes depending on the direction of current flow through the first coil 33a. Similar Lorentz forces are also generated in the second magnetic circuit and second coil 33b, and in the third magnetic circuit and third coil 33c. The first actuator generates a translational force in the X direction. The second actuator and the third actuator generate forces approximately parallel to the Y direction, the sum of the respective forces generates a translational force in the Y direction, and a difference between the respective forces generates a rotational force around the optical axis.

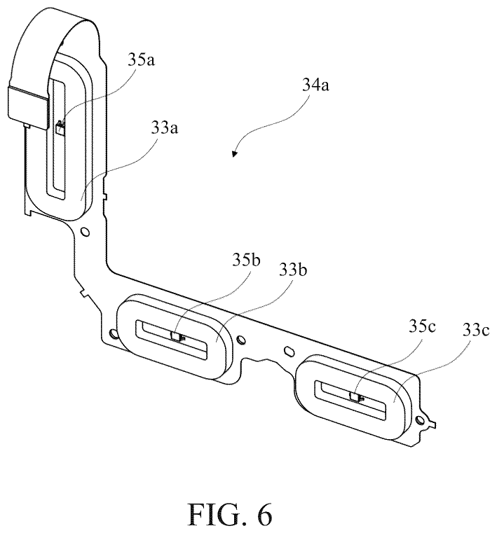

Referring now to FIG. 6, a description will be given of a structure of the drive FPC 34a constituting the movable portion 30. FIG. 6 is a perspective view of the drive FPC 34a. A first detection element 35a, a second detection element 35b, and a third detection element 35c are attached to the drive FPC 34a. The first detection element 35a, the second detection element 35b, and the third detection element 35c are a second detector that detects position information on the holding member 31 relative to the base plate 21.

The first detection element 35a is disposed inside the first coil 33a, the second detection element 35b is disposed inside the second coil 33b, and the third detection element 35c is disposed inside the third coil 33c. Each of the first detection element 35a, the second detection element 35b, and the third detection element 35c is, for example, a Hall element. The first detection element 35a detects the magnetic force of the first magnetic circuit, and the first image-stabilizing control unit 15a calculates position information (more specifically a position and an angle around the optical axis) on the movable portion 30 relative to the fixed portion 20 in the optical-axis orthogonal plane 12c based on the detection result of the first detection element 35a. This is similarly applicable to the second detection element 35b and the third detection element 35c.

The first coil 33a, the second coil 33b, and the third coil 33c are electrically connected to the drive FPC 34a, and the first image-stabilizing control unit 15a controls the current flowing through each coil via the drive FPC 34a. That is, the first image-stabilizing control unit 15a performs feedback control based on the deviation between a moving target value of the image sensor 11 based on the image stabilizing information detected by the first shake detector 16a and the current position information on the image sensor 11 detected by each detection element (Hall element). Thereby, the first image-stabilizing control unit 15a controls the driving of the movable portion 30.

The movable portion 30 is supported on the base plate 21 via balls (rollable members) 26a, 26b, and 26c movably within the optical-axis orthogonal plane 12c. The balls 26a, 26b, and 26c are respectively arranged inside a first enclosing portion 31d, a second enclosing portion 3l, and a third enclosing portion 31f provided to the holding member 31. In a case where the movable portion 30 moves in the optical-axis orthogonal plane 12c relative to the fixed portion 20, the balls 26a, 26b, and 26c roll, so the load due to frictions with the holding member 31 and the base plate 21 is small.

The movable portion 30 further includes a thrust magnet 38 and a second thrust yoke (second yoke member) 37. The thrust magnet 38 and the second thrust yoke 37 are disposed at a position facing the first thrust yoke 27 disposed in the fixed portion 20, and are fixed to the holding member 31 with screws, adhesive, or the like (not illustrated). The thrust magnet 38 forms a fourth magnetic circuit that passes through the first thrust yoke 27 and the second thrust yoke 37. The movable portion 30 is biased in the optical axis direction (−Z direction) toward the base plate 21 by the suction force generated between the thrust magnet 38 and the first thrust yoke 27. That is, the thrust magnet 38, the first thrust yoke 27, and the second thrust yoke 37 constitute a first biasing portion that biases the movable portion 30 toward the fixed portion 20 in the optical axis direction (−Z direction).

The movable portion 30 further includes a first thrust metal plate 36a and a second thrust metal plate 36b. The first thrust metal plate 36a is disposed at a position facing the first rear magnet unit 23a, the second thrust metal plate 36b is disposed at a position facing the third rear magnet unit 23c, and the first thrust metal plate 36a and the second thrust metal plate 36b are fixed to the drive FPC 34a with an adhesive or the like. The first thrust metal plate 36a and the second thrust metal plate 36b are formed of a magnetic material, and generate a suction force between the opposing first rear magnet unit 23a and second rear magnet unit 23b. That is, the first thrust metal plate 36a and the second thrust metal plate 36b respectively constitute a second biasing portion and a third biasing portion that bias the movable portion 30 toward the fixed portion 20.

The first, second, and third biasing portions are arranged so that the center of gravity of the movable portion 30 is located inside a triangle formed by connecting the biasing portions on the optical-axis orthogonal plane 12c. This is similarly applicable to the arrangement of the balls 26a, 26b, and 26c. As a result, well-balanced biasing forces can be generated on the movable portion 30. Thus, the movable portion 30 can be prevented from floating up during driving.

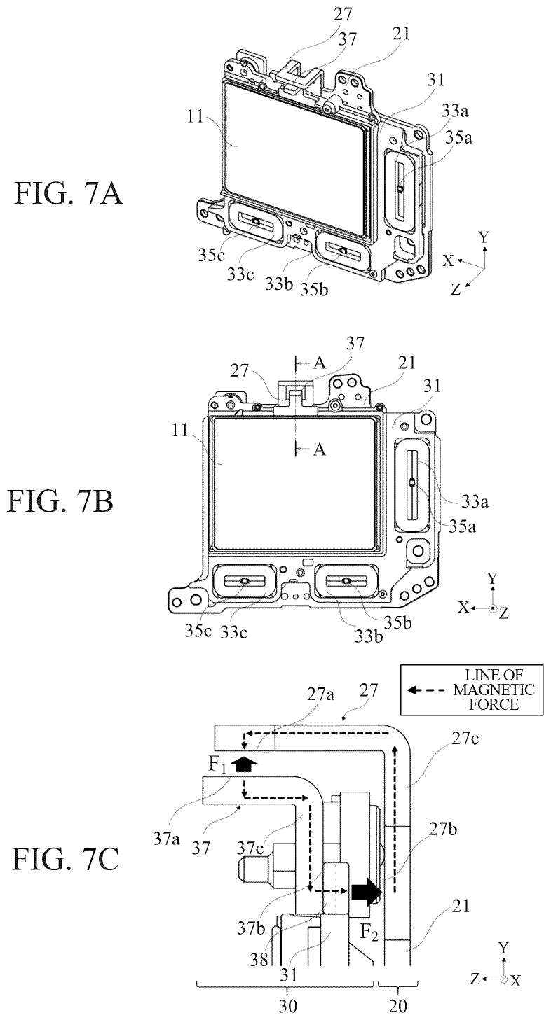

Referring now to FIGS. 7A to 7C, a detailed description will be given of the first biasing portion (holding assist structure) composed of the thrust magnet 38, the first thrust yoke 27, and the second thrust yoke 37. FIG. 7A is a perspective view of the first image stabilizing unit 50, FIG. 7B is a front view of the first image stabilizing unit 50, and FIG. 7C is a sectional view taken along a line A-A in FIG. 7B. FIGS. 7A to 7C illustrate only parts relating to the description of the first biasing portion.

As described above, the first thrust yoke 27 is fixed to the base plate 21 constituting the fixed portion 20, and the thrust magnet 38 and the second thrust yoke 37 are disposed on the holding member 31 constituting the movable portion 30.

As illustrated in FIG. 7C, the first thrust yoke 27 and the second thrust yoke 37 have a first surface 27a and a second surface 37a that overlap (face) each other on a projection plane in the vertical direction (Y direction), and are adjacent to each other in the vertical direction (Y direction). The first thrust yoke 27 and the second thrust yoke 37 have a third surface 27b and a fourth surface 37b that overlap (face) each other on a projection plane in the optical axis direction (Z direction). The first thrust yoke 27 has a first connector 27c that connects the first surface 27a and the third surface 27b. The second thrust yoke 37 has a second connector 37c that connects the second surface 37a and the fourth surface 37b.

The thrust magnet 38 is disposed so that it contacts the fourth surface 37b of the second thrust yoke 37, and is fixed to the second thrust yoke 37 with screws, adhesive, or the like (not illustrated). The thrust magnet 38 is disposed so that the magnetization direction is parallel to the optical axis direction (Y direction). Thus, the thrust magnet 38 forms a fourth magnetic circuit passing through the first thrust yoke 27 and the second thrust yoke 37, as illustrated by the dashed arrow in FIG. 7C.

The fourth magnetic circuit generates a suction force (second biasing force) F2 between the thrust magnet 38 and the third surface 27b of the first thrust yoke 27. The movable portion 30 is biased toward the base plate 21 by the suction force F2.

The fourth magnetic circuit generates a suction force (first biasing force) F1 between the first surface 27a of the first thrust yoke 27 and the second surface 37a of the second thrust yoke 37. In this embodiment, the first surface 27a (one surface of the fixed portion 20) is disposed above the second surface 37a (one surface of the movable portion 30) in the vertical direction (Y direction). Thereby, the suction force F1 can be generated in the +Y direction (opposite to the gravity direction at the normal position). In other words, the suction force F1 can be applied in a direction that cancels the weight of the movable portion 30, and thus the drive force of the VCM necessary to hold the movable portion 30 can be reduced (holding assist effect). Thus, the power consumption associated with holding the movable portion 30 can be reduced. In addition, the generator of the suction force F1 utilizes the magnetic circuit of the first biasing portion. Hence, no additional dedicated parts or mechanisms are required, and thus this structure can prevent the size of the first image stabilizing unit 50 from increasing or prevent the number of parts from increasing.

The suction force F1 may be always set to be smaller than the weight of the movable portion 30 in the drive control range of the movable portion 30. That is, the suction force F1 is smaller than the gravity acting on the holding member 31 in the drivable range of the holding member 31 by the drive unit. For example, if the suction force F1 exceeds the weight of the movable portion 30, the movable portion 30 is biased in the +Y direction by the suction force F1. Thus, this causes a drive load in driving the movable portion 30, and the driving controllability (i.e., vibration controllability) of the movable portion 30 may decrease. Accordingly, setting the suction force F1 to always be smaller than the weight of the movable portion 30 can reduce the power consumption without decreasing the driving controllability of the movable portion 30.

In this embodiment, the thrust magnet 38 is disposed on the movable portion 30 (fourth surface 37b), but this embodiment is not limited to this example. Even if the thrust magnet 38 is disposed on the fixed portion 20 (third surface 27b), the suction forces F2 and F1 similarly act, so they may be disposed on the fixed portion 20 (third surface 27b).

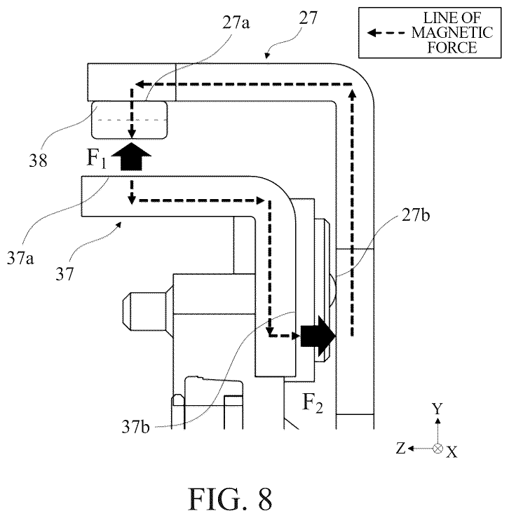

Referring now to FIG. 8, a description will be given of a variation of this embodiment. FIG. 8 is a sectional view of the first biasing portion (holding assist structure) according to the variation, illustrating an example in which the thrust magnet 38 in FIG. 7C is disposed on the first surface 27a of the first thrust yoke 27. As illustrated in FIG. 8, the thrust magnet 38 may be disposed on the first surface 27a or the second surface 37a so that the magnetization direction of the thrust magnet 38 is parallel to the vertical direction (Y direction). Even in the structure illustrated in FIG. 8, a magnetic circuit equivalent to the fourth magnetic circuit in FIG. 7C can be formed, and the suction forces F2 and F1 can be similarly applied.

As described above, in this embodiment, the thrust magnet 38 is disposed on one of the third surface 27b and the fourth surface 37b so that the magnetization direction coincides with the second direction. This embodiment is not limited to this example, and the thrust magnet 38 may be disposed on one of the first surface 27a and the second surface 37a so that the magnetization direction coincides with the first direction, as in the variation described with reference to FIG. 8. In either arrangement, the holding member 31 is biased in the first direction toward the base plate 21 via the first surface 27a and the second surface 37a by the first biasing force. The holding member 31 is biased in the second direction toward the base plate 21 via the third surface 27b and the fourth surface 37b by the second biasing force.

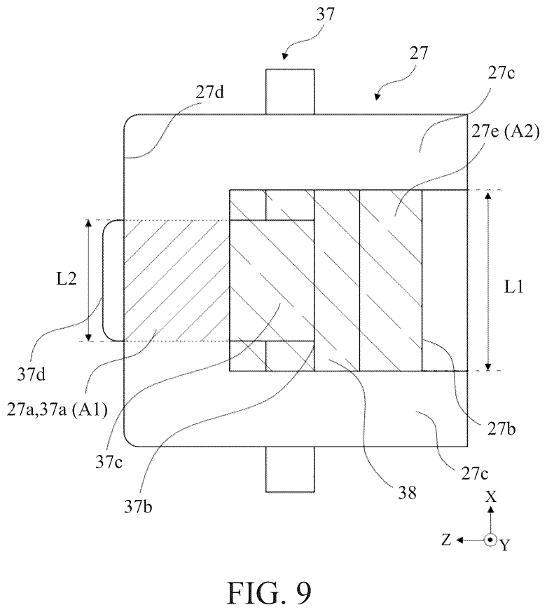

Referring now to FIG. 9, a description will be given of the shapes of the first thrust yoke 27 and the second thrust yoke 37. FIG. 9 is a top view (projected view) of the first biasing portion as viewed from the +Y direction. A hatched area A1 in FIG. 9 covers the first surface 27a of the first thrust yoke 27 and the second surface 37a of the second thrust yoke 37, which overlap each other on the projection plane in the vertical direction (Y direction).

A shaded area A2 in FIG. 9 is an opening 27e formed in the first connector 27c of the first thrust yoke 27. The opening 27e is provided so that the first connector 27c of the first thrust yoke 27 and the second connector 37c of the second thrust yoke 37 do not overlap each other on the projection surface in the vertical direction (Y direction). Providing the opening 27e can increase a distance between the first connector 27c and the second connector 37c, and restrain the magnetic flux passing through the first thrust yoke 27 from leaking between the first connector 27c and the second connector 37c. Therefore, the decrease in the suction force F1 due to the leakage of the magnetic flux can be suppressed, and the holding assist effect can be efficiently exhibited.

Assume that L1 is a length in the horizontal direction (X direction, third direction) of the opening 27e, L2 is a length in the horizontal direction (X direction) of the second surface 37a of the second thrust yoke 37, and L3 is a maximum drive amount of the movable portion 30 in the horizontal direction (X direction) (not illustrated). In this embodiment, the opening 27e is formed so as to satisfy the following inequality: L1>L2+L3. Satisfying this inequality can prevent the second surface 37a of the second thrust yoke 37 from overlapping the first connector 27c of the first thrust yoke 27 in the vertical direction (Y direction) within the control range (drivable range) of the movable portion 30. Thereby, the area on which the suction force F1 acts (the (first) area where the first surface 27a and the second surface 37a overlap each other in the vertical direction) can be constant. Thus, the generation of a force component of the suction force F1 in the horizontal direction (X direction) can be suppressed, and the drive controllability (i.e., image stabilizing controllability) of the movable portion 30 can be improved.

An end 37d of the second surface 37a of the second thrust yoke 37 in the optical axis direction (+Z direction) is disposed outside an end 27d of the first surface 27a of the first thrust yoke 27 in the optical axis direction (+Z direction). If the end 37d of the second surface 37a is disposed inside the end 27d of the first surface 27a, a magnetic force acts from the first surface 27a toward the second surface 37a, and thus the suction force F1 is generated obliquely relative to the vertical direction (Y direction). Therefore, the holding assist effect of the suction force F1 in the vertical direction (Y direction) is reduced. In addition, since a force component in the opposite direction (+Z direction) to the suction force F2 is generated, a sufficient biasing force may not be able to be obtained, or the size of the thrust magnet 38 increases to secure the necessary biasing force. In consideration of this possibility, an efficient magnetic circuit can be formed by disposing the end 37d of the second surface 37a outside the end 27d of the first surface 27a.

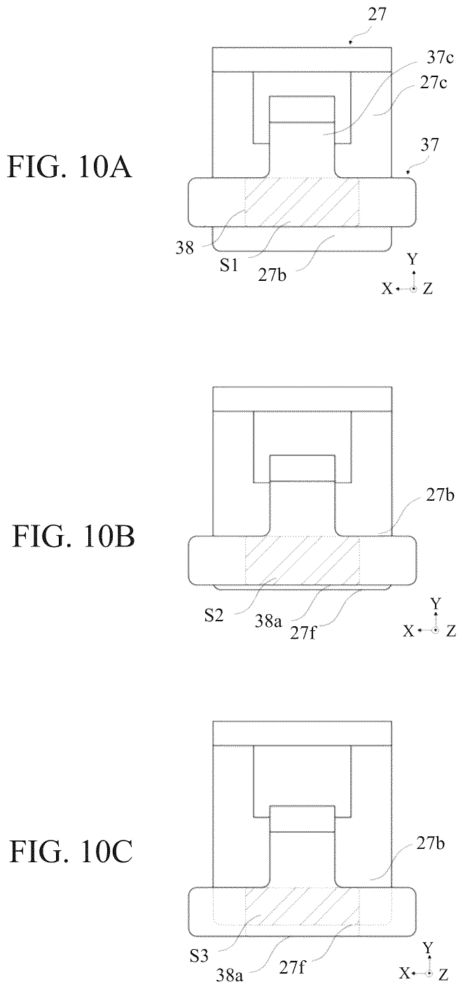

Referring now to FIGS. 10A to 10C, a description will be given of a relationship between the thrust magnet 38 and the third surface 27b of the first thrust yoke 27. FIGS. 10A to 10C are front views of the first biasing unit viewed from the +Z direction in the normal position orientation of the imaging system 10. FIG. 10A illustrates that the movable portion 30 is held at a position that is substantially coincides with the optical axis 12a (i.e., held at the center). FIG. 10B illustrates a state in which the movable portion 30 has moved to the maximum position movable in the −Y direction within its control range. FIG. 10C illustrates power-off states of the first coil 33a, the second coil 33b, and the third coil 33c (i.e., the imaging system 10 is powered off). At this time, the movable portion 30 is stationary in contact with one of the first support member 24a, the second support member 24b, and the third support member 24c.

In the state of FIG. 10A, the area of a region where the thrust magnet 38 and the third surface 27b of the first thrust yoke 27 overlap each other on the projection plane in the optical axis direction (Z direction) is defined as S1. Similarly, the area in the state of FIG. 10B is defined as S2, and the area in the state of FIG. 10C is defined as S3.

As illustrated in FIGS. 10A and 10B, the thrust magnet 38 may be disposed so that the overlapping area between the thrust magnet 38 and the third surface 27b in the optical axis direction (Z direction) is constant (S1=S2) within the control range of the movable portion 30. That is, the size of the area (second area) may be constant where the thrust magnet 38 and the third surface 27b or the fourth surface 37b, which faces the thrust magnet 38 via a predetermined gap, overlap each other in the optical axis direction (second direction).

In driving the movable portion 30, making the area constant can suppress the generation of the force component of the suction force F2 acting on the thrust magnet 38 in the optical-axis orthogonal direction (XY plane direction), and improve the drive controllability (i.e., image stabilizing controllability) of the movable portion 30. While FIG. 10B illustrates only a state in which the movable portion 30 has moved to the maximum position in the −Y direction within the control range, the position is limited to the maximum position and the area may be constant throughout the control range within the optical-axis orthogonal plane 12c (XY plane). Thereby, the decrease in drive controllability can be suppressed, which accompanies the generation of the force component of the suction force F2 in the optical-axis orthogonal direction (XY plane direction) throughout the entire control range of the movable portion 30.

On the other hand, as illustrated in FIG. 10C, while the imaging system 10 is powered off, the end 38a in the −Y direction (lower end) of the thrust magnet 38 may be located lower than the end 27f in the −Y direction (lower end) of the third surface 27b of the first thrust yoke 27. That is, while the holding member 31 moves downward and contacts the restricting portion (24a to 24c), the end 38a may be located closer to the end 27f of the third surface 27b or the fourth surface 37b, which faces the thrust magnet 38 via a predetermined gap.

At this time, the overlapping area of the thrust magnet 38 and the third surface 27b in the optical axis direction (Z direction) in the power-off state is smaller than the above area within the control range of the movable portion 30, that is, S3<S1=S2. In a case where the relationship is satisfied, the suction force F2 acting on the thrust magnet 38 generates a force component in the +Y direction (opposite to the gravity direction at the normal position). Therefore, in the power-off state, the suction force F2 can be made to act in a direction that cancels the weight of the movable portion 30. Thus, the drive force of the VCM can be reduced, which is required for the return operation of the body unit 10a from the power-off state (FIG. 10C) to the center holding state (FIG. 10A) by turning the power ON (return assist effect). Therefore, the power consumption associated with the return operation of the movable portion 30 can be reduced.

As described above, in this embodiment, the first surface 27a of the first thrust yoke 27 and the second surface 37a of the second thrust yoke 37 overlap each other in the first direction (Y direction) orthogonal to the optical axis direction (Z direction). The third surface 27b of the first thrust yoke 27 and the fourth surface 37b of the second thrust yoke 37 overlap each other in the second direction (Z direction) parallel to the optical axis 12a. The thrust magnet 38, the first thrust yoke 27, and the second thrust yoke 37 form a magnetic circuit passing through the first surface 27a, the second surface 37a, the third surface 27b, and the fourth surface 37b.

The first direction may be parallel to the gravity direction (−Y direction) when the body unit 10a is located at a predetermined position, and the first surface 27a is disposed on the opposite side (upper side) of the gravity direction with respect to the second surface 37a. The predetermined position may be the normal position of body unit 10a, and the first direction is the height direction of body unit 10a. The first surface 27a and second surface 37a may face each other in the first direction, and third surface 27b and fourth surface 37b face each other in the second direction.

This embodiment can provide an image pickup apparatus that has a simple structure and can reduce power consumption regardless of the attitude of the image pickup apparatus.

While the disclosure has described example embodiments, it is to be understood that some embodiments are not limited to the disclosed embodiments. The scope of the following claims is to be accorded the broadest interpretation so as to encompass all such modifications and equivalent structures and functions.

This application claims priority to Japanese Patent Application No. 2023-209448, which was filed on Dec. 12, 2023, and which is hereby incorporated by reference herein in its entirety.

What is claimed is:

1. An image pickup apparatus comprising:
a fixed member;
a movable member holding an image sensor and movable relative to the fixed member in a direction orthogonal to an optical axis;
a drive unit configured to drive the movable member;
a rollable member disposed between the fixed member and the movable member;
a first yoke member disposed on the fixed member;
a second yoke member disposed on the movable member; and
a magnet member disposed on one of the first yoke member and the second yoke member,
wherein a first surface of the first yoke member and a second surface of the second yoke member overlap each other in a first direction orthogonal to an optical axis direction,
wherein a third surface of the first yoke member and a fourth surface of the second yoke member overlap each other in a second direction parallel to the optical axis, and
wherein the magnet member, the first yoke member, and the second yoke member form a magnetic circuit passing through the first surface, the second surface, the third surface, and the fourth surface.

2. The image pickup apparatus according to claim 1, wherein the first direction is parallel to a gravity direction when the image pickup apparatus is located at a predetermined position, and
wherein the first surface is disposed on an opposite side of the gravity direction with respect to the second surface.

3. The image pickup apparatus according to claim 2, wherein the predetermined position is a normal position of the image pickup apparatus, and
wherein the first direction is a height direction of the image pickup apparatus.

4. The image pickup apparatus according to claim 1, wherein the first surface and the second surface face each other in the first direction, and
wherein the third surface and the fourth surface face each other in the second direction.

5. The image pickup apparatus according to claim 1, wherein the magnet member is disposed on one of the third surface and the fourth surface such that a magnetization direction coincides with the second direction,
wherein the movable member is biased in the first direction toward the fixed member via the first surface and the second surface by a first biasing force, and
wherein the movable member is biased in the second direction toward the fixed member via the third surface and the fourth surface by a second biasing force.

6. The image pickup apparatus according to claim 5, wherein the first biasing force is smaller than gravity acting on the movable member within a drivable range of the movable member by the drive unit.

7. The image pickup apparatus according to claim 1, wherein the first yoke member includes a first connector connecting the first surface and the third surface,
wherein the second yoke member includes a second connector connecting the second surface and the fourth surface, and
wherein the first connector has an opening such that the first connector and the second connector do not overlap with each other in the first direction.

8. The image pickup apparatus according to claim 7, wherein the opening is formed within a drivable range of the movable member by the drive unit such that a first area by which the first surface and the second surface overlap with each other in the first direction is constant.

9. The image pickup apparatus according to claim 1, wherein an end of the second surface is disposed outside an end of the first surface in the second direction.

10. The image pickup apparatus according to claim 1, wherein within a drivable range of the movable member by the drive unit, a second area is constant by which the third surface or the fourth surface, which faces the magnet member via a predetermined gap, and the magnet member overlap each other in the second direction.

11. The image pickup apparatus according to claim 1, further comprising a restricting portion configured to restrict a movement of the movable member, and
wherein while the movable member moves downward in the first direction and contacts the restricting portion, a lower end portion of the magnet member in the first direction is disposed lower in the first direction than a lower end portion of the third surface or the fourth surface in the first direction, which faces the magnet member via a predetermined gap.

12. The image pickup apparatus according to claim 1, wherein the magnet member is disposed on one of the first surface and the second surface such that a magnetization direction coincides with the first direction,
wherein the movable member is biased toward the fixed member in the first direction via the first surface and the second surface by a first biasing force, and
wherein the movable member is biased toward the fixed member in the second direction via the third surface and the fourth surface by a second biasing force.

13. The image pickup apparatus according to claim 1, further comprising a processor configured to control the drive unit,
wherein the drive unit includes:
a coil held by the movable member,
another magnet member held by the fixed member,
a first detector configured to detect blur information on the fixed member, and
a second detector configured to detect position information on the movable member relative to the fixed member, and
wherein the processor is configured to control the movable member based on the blur information and the position information.
